(19) United States
(12) Patent Application Publication
(10) Pub. No.: US 2014/0303852 A1
(43) Pub. Date: Oct. 9, 2014

(54) AUTOMATIC DOOR OPERATING DEVICE FOR VEHICLE

(71) Applicant: AISIN SEIKI KABUSHIKI KAISHA, Kariya-shi (JP)

(72) Inventors: Tomokazu SEKI, Kariyas-shi (JP); Norio Fukui, Kuwana-shi (JP)

(73) Assignee: AISIN SEIKI KABUSHIKI KAISHA, Kariya-shi (JP)

(21) Appl. No.: 14/229,322

(22) Filed: Mar. 28, 2014

(30) Foreign Application Priority Data
Apr. 5, 2013 (JP) 2013-079072

(51) Int. Cl. E05F 15/20

(52) U.S. Cl. CPC E05F 15/2038
USPC 701/49

(57) ABSTRACT

An automatic door operating device for a vehicle includes: an input unit which is provided in a portion of a vehicle and to which an instruction to automatically open a door of a vehicle is input by a user's touch; a door drive unit configured to automatically open the door based on the instruction input by the input unit; and a controller configured to control the door drive unit so as to automatically open the door only while the user touches the input unit.

### CROSS REFERENCE TO RELATED APPLICATIONS

This application is based on and claims priority under 35 U.S.C. §119 to Japanese Patent Application 2013-079072, filed on Apr. 5, 2013, the entire contents of which are incorporated herein by reference.

### TECHNICAL FIELD

This disclosure relates to an automatic door operating device for a vehicle, and more particularly to an automatic door operating device for a vehicle by which the user operates doors (for example, a side door, a back door, a trunk lid, and the like) present in a vehicle from outside of the vehicle.

### BACKGROUND DISCUSSION

In the related art, a technology has been proposed in which a user opens and closes a door of a vehicle without touching the door. JP 2010-13824A (Reference 1) discloses a technology which captures an image of a hand of the user by a camera and detects the position of the hand relative to the door. The opening and closing of the door is automatically performed based on the image captured by the camera and the detected position of the hand. For example, a form of the hand representing an intention to open the door (an open form) and a form of the hand representing an intention to close the door (a closing form) are set in a control device according to JP 2010-13824A (Reference 1). When it is determined that the form of the hand of the user is the open form from a result of analyzing an image captured by the camera and the hand of the user is not separated by a predetermined distance or more from the door, the control device automatically opens the door. Similarly, when it is determined that the form of the hand of the user is the closing form from a result of analyzing an image captured by the camera and the hand of the user is not separated by a predetermined distance or more from the door, the control device automatically closes the door. In the technology disclosed in JP 2010-13824A (Reference 1), even if the form of the hand of the user is the open form or the closing form from a result of analyzing an image captured by the camera, when the hand of the user is separated by a predetermined distance or more from the door, the gesture of the user is ignored and the opening and closing operation of the door is not performed.

In the technology disclosed in JP 2006-274677A (Reference 2), the camera is provided to capture a whole image of the user located in the vicinity of the vehicle. The control device recognizes the state of the hand of the user based on the image captured by the camera, and when it is determined that the hand of the user is closed from a result of analyzing the captured image, the control device automatically opens the door. In other words, when the hand of the user present in the shooting range of the camera is closed, the control device determines that the user intends to automatically open the door, and automatically opens the door. In contrast, when the hand of the user present in the shooting range of the camera is not closed, the control device determines that the user is able to perform the door opening operation by oneself and does not automatically open the door. In this case, the user operates a door handle by oneself to perform the door opening operation.

As described above, in JP 2010-13824A (Reference 1) and JP 2006-274677A (Reference 2), the control device that performs the control of the automatic opening and closing of the door analyzes the image captured by a camera and recognizes the intention of the user regarding the opening and closing of the door. Therefore, the intention of the user regarding the opening and closing of the door may not be reflected accurately. For example, if it rains or it is foggy, the image captured by the camera is blurred, and the control device may not accurately recognize the user status (the form of the hand or the status of the hand being closed), and may incorrectly recognize the user status. This leads to a malfunction in the automatic door opening and closing. Alternatively, in a case where the vicinity of the vehicle is dark (for example, at night), the image captured by the camera becomes dark and the status of the user may not be captured accurately. In this manner, in JP 2010-13824A (Reference 1) and JP 2006-274677A (Reference 2), the intention of the user regarding the opening and closing of the door may not be accurately determined depending on the weather and the illumination of the vicinity of the vehicle.

Further, the shooting area of the camera changes due to unexpected events and a light receiving unit of the camera may be blocked by something, so that a situation may occur where the door opening and closing operation is not performed.

Further, in both JP 2010-13824A (Reference 1) and JP 2006-274677A (Reference 2), at the time of shooting by the camera for the determining of the intention of the user regarding the opening and closing of the door, when a plurality of people are in the shooting area of the camera, the camera generates a captured image that contains the plurality of people. In both JP 2010-13824A (Reference 1) and JP 2006-274677A (Reference 2), when a plurality of people appear in the image captured by the camera, there is no description regarding which person is considered as material for the determination. Therefore, it may be difficult for a control device according to either JP 2010-13824A (Reference 1) or JP 2006-274677A (Reference 2) to determine which person has an intention regarding the opening and closing of the door among the plurality of people contained in the captured image. Accordingly, in the technologies disclosed in JP 2010-13824A (Reference 1) and JP 2006-274677A (Reference 2), the intention of the user regarding the opening and closing of the door may not be recognized accurately depending on the number and the arrangement of people in the vicinity of the vehicle (particularly, the shooting area of the camera).

In JP 2010-13824A (Reference 1), after the form of the hand is recognized, from the detection result of the position of the hand of the user relative to the door, if the hand of the user does not touch the door or is not located at a position less than a predetermined distance, the automatic opening and closing operation of the door is not performed. Therefore, even if the user having an intention to open the door forms the hand into an open form, when the position of the hand shaped into the open form is separated by a predetermined distance, which is set in a target vehicle, or more, the door is not automatically opened. In other words, the situation where the opening and closing operation desired by the user is not performed may occur.

First of all, in JP 2010-13824A (Reference 1), the user needs to make the control device of the vehicle recognize the open form and the closing form which are set in the vehicle through the camera, and to place the hand of the user less than a predetermined distance from the door at the time of operation of the door. Therefore, a person who does not know the shape of the open form, the closing form and the predetermined distance which are set in the vehicle (for example, a person who first boards the vehicle) cannot open the door of the vehicle.

Further, in JP 2006-274677A (Reference 2), the control device recognizes the intention of the user to automatically open the door by analyzing the image captured by the camera and by determining whether or not the hand of the user is closed. In other words, when it is determined that the hand of the user is closed, the control device determines that the user desires to automatically open the door, and performs an automatic opening operation of the door. Therefore, even if the user does not desire to automatically open the door, when the user makes a gesture that may be determined by the control device as the hand of the user being closed within a shooting range of the camera, the door is automatically opened. In other words, the door is automatically opened contrary to the intention of the user.

In an aspect of JP 2006-274677A (Reference 2), in order to clarify the intention of the user, the control device further determines whether or not the user faces the front in the captured image. Then, from the analysis result of the captured image, when it is determined that the user faces the front and the hand is closed, the door is automatically opened.

However, in this aspect, even if the user is going to face the front, when the control device determines that the user does not face the front in the captured image, the door is not automatically opened. Further, depending on the status of the user, in some cases, the user has no intention to open the door, but the user wants to check the inside of the vehicle while looking through the door window in a state where the hand is closed. In such a case, the user is likely to face the front for the camera. Therefore, since the user faces the front and the hand is closed, despite the user not intending to open the door, the control device according to JP 2006-274677A (Reference 2) automatically opens the door, according to the analysis result of the image captured by the camera.

### SUMMARY

Thus, a need exists for an automatic door operating device for a vehicle capable of accurately recognizing the instruction from the user to automatically open the doors (for example, a side door, a back door, a trunk lid, and the like) of a vehicle, and of the user accurately inputting the instruction to automatically open the vehicle door.

A first aspect of this disclosure is directed to an automatic door operating device for a vehicle including: an input unit which is provided in a portion of a vehicle and to which an instruction to automatically open a door of a vehicle is input by a user's touch; a door drive unit configured to automatically open the door based on the instruction input by the input unit; and a control mechanism configured to control the door drive unit so as to automatically open the door only while the user touches the input unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a vehicle according to an embodiment of the present disclosure;

FIG. 2 is a diagram showing a side door according to the embodiment of the present disclosure;

FIG. 3 is a schematic configuration diagram of an automatic door operating device for a vehicle according to the embodiment of the present disclosure;

FIG. 4A illustrates a flow chart showing a processing procedure of an automatic opening and closing operation according to the embodiment of the present disclosure;

FIG. 4B illustrates a flow chart showing a processing procedure of the automatic opening and closing operation according to the embodiment of the present disclosure;

FIG. 5 illustrates a flow chart showing a processing procedure of the automatic opening and closing operation according to the embodiment of the present disclosure;

FIG. 6 illustrates a flow chart showing a processing procedure of the automatic opening and closing operation according to the embodiment of the present disclosure;

FIG. 7 is a diagram showing a side door according to another embodiment of the present disclosure; and

FIG. 8 is a diagram showing a side door according to still another embodiment of the present disclosure.

### DETAILED DESCRIPTION

Hereinafter, embodiments disclosed herein will be described with reference to drawings, but the disclosure is not limited to the present embodiments. In addition, in the drawings described below, components having the same functions are given the same reference numerals, and the redundant description thereof will be omitted.

### Embodiment 1

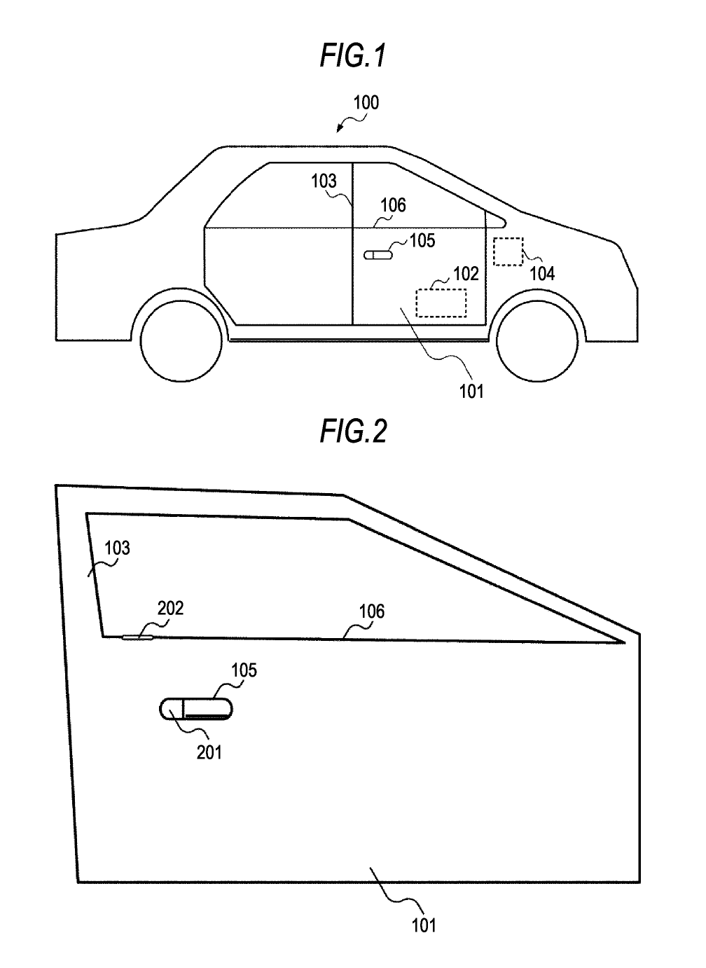

FIG. 1 is a side view of a vehicle according to an embodiment of the present disclosure.

In FIG. 1, a vehicle 100 includes a side door 101 as an opening and closing body which is openable and closable, and a door opening and closing drive unit 102 that automatically opens and closes the side door 101. The reference numeral 103 is a garnish provided in a center pillar of the vehicle 100. Further, the side door 101 includes a door handle 105 for the user to open and close manually the side door 101, and a belt molding 106 made from a resin. For example, the door opening and closing drive unit 102 is an actuator, and operates to perform an automatic opening and closing of the side door 101 when an operation signal is received from a control device described below.

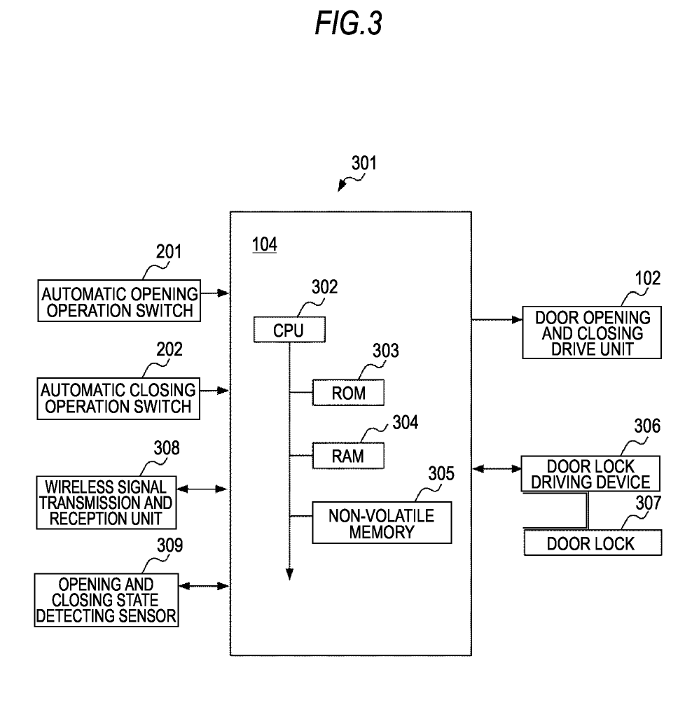

FIG. 2 is a diagram showing the side door 101.

An automatic opening operation switch 201 is embedded in the door handle 105. The automatic opening operation switch 201 allows the user to input an instruction to automatically open the side door 101, which in this embodiment is a right front door in a forward direction of the vehicle 100. Further, an automatic closing operation switch 202 is embedded in the belt molding 106. The automatic closing operation switch 202 allows the user to input an instruction to automatically close the side door 101. In the description below, “the instruction to automatically open the side door 101 from the user” will be referred to as “an opening operation instruction”, and “the instruction to automatically close the side door 101 from the user” will be referred to as “a closing operation instruction”. Further, “the instruction from the user to stop the side door 101 in the middle of the automatic operation” will be referred to as “intermediate stop instruction”.

In this manner, in the present embodiment, the input unit for inputting an opening operation instruction and the input unit for inputting a closing operation instruction are separately provided.

In addition, although the whole belt molding 106 may be made from a resin or most parts thereof may be made from a metal, some parts of the whole belt molding 106 in which the automatic closing operation switch 202 is embedded may be made from a resin.

In the present embodiment, both the automatic opening operation switch 201 and the automatic closing operation switch 202 are capacitive sensors, a contact type sensor. Therefore, when the user touches the part covering the automatic opening operation switch 201 of the door handle 105 and the part in the vicinity thereof, the automatic opening operation switch 201 detects the opening operation instruction from the user, and transmits opening operation instruction information regarding the opening operation instruction to a control device 104. In other words, in the present embodiment, the automatic opening operation switch 201 including parts corresponding to the automatic opening operation switch 201 of the door handle 105 (i.e., the part covering the automatic opening operation switch 201 of the door handle 105 and the part in the vicinity thereof) function as the input unit for inputting the opening operation instruction. Further, in a form in which the automatic opening operation switch 201 is exposed while not being embedded in the door handle 105, the automatic opening operation switch 201 transmits the opening operation instruction information to the control device 104 by the user touching the automatic opening operation switch 201.

In contrast, when the user touches the part covering the automatic closing operation switch 202 of the belt molding 106 and the part in the vicinity thereof, the automatic closing operation switch 202 detects the closing operation instruction from the user, and transmits closing operation instruction information regarding the closing operation instruction to the control device 104. In other words, in the present embodiment, the automatic closing operation switch 202 including parts corresponding to the automatic closing operation switch 202 of the belt molding 106 (the part covering the automatic closing operation switch 202 of the belt molding 106 and the part in the vicinity thereof) function as the input unit for inputting the closing operation instruction. Further, in the present embodiment, the automatic closing operation switch 202 is exposed and not entirely embedded in the belt molding 106. The automatic closing operation switch 202 transmits the closing operation instruction information to the control device 104 by the user touching the automatic closing operation switch 202.

In addition, in the present embodiment, when a contact sensor (for example, the automatic opening operation switch 201 or the automatic closing operation switch 202) is embedded in a predetermined member (for example, the door handle, the belt molding, the garnish, or the like), in order to simplify the description, the description of “touching the part corresponding to the contact sensor in the predetermined member” will be referred to as “touching the contact sensor”.

Further, when it is detected that a transition is made from a state where the user has been touching the automatic opening operation switch 201 to a state where the user is not touching the automatic opening operation switch 201(for example, by the user separating the hand touching the automatic opening operation switch 201 from the automatic opening operation switch 201), the automatic opening operation switch 201 transmits touching end information indicating the detection result to the control device 104. In the present embodiment, in the automatic opening operation of the side door 101, the user's separating the hand touching the automatic opening operation switch 201 before the side door 101 is fully opened is an input of an intermediate stop instruction which is input by the user. Therefore, the touching end information generated when the user releases the hand touching the automatic opening operation switch 201 before the side door 101 is fully opened in the automatic opening operation is intermediate stop instruction information regarding an intermediate stop instruction.

Similarly, when it is detected that a transition is made from a state where the user has been touching the automatic closing operation switch 202 to a state where the user is not touching the automatic closing operation switch 202(for example, by the user separating the hand touching the automatic closing operation switch 202 from the automatic closing operation switch 202), the automatic closing operation switch 202 transmits touching end information indicating the detection result to the control device 104. In the present embodiment, in the automatic closing operation of the side door 101, the user's separating the hand touching the automatic closing operation switch 202 before the side door 101 is fully closed is also an intermediate stop instruction which is input by the user. Therefore, the touching end information generated when the user releases the hand touching the automatic closing operation switch 202 before the side door 101 is fully closed in the automatic closing operation is also intermediate stop instruction information regarding an intermediate stop instruction.

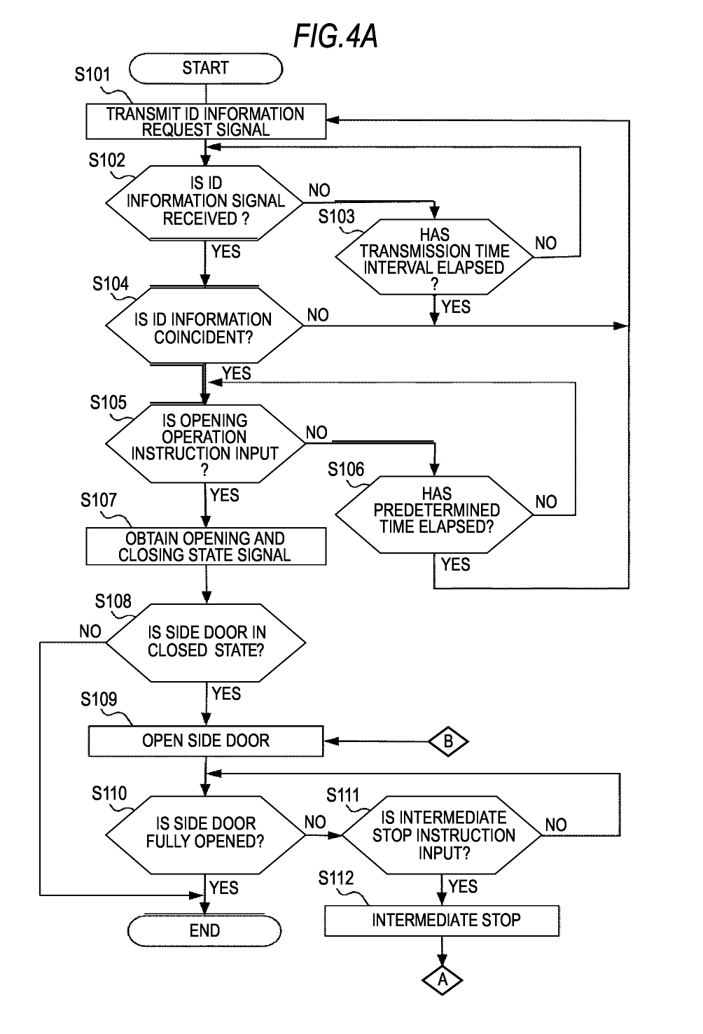

FIG. 3 is a schematic configuration diagram of an automatic door operating device for a vehicle according to the present embodiment.

In FIG. 3, an automatic door operating device for a vehicle 301 includes a door opening and closing drive unit 102, a control device 104, an automatic opening operation switch 201, an automatic closing operation switch 202, a door lock driving device 306 that locks or unlocks a door lock 307 of the side door 101, a wireless signal transmission and reception unit 308 that transmits and receives wireless signals with a wireless transmitter (not shown), and an opening and closing state detecting sensor 309 that detects an opening and closing state of the side door 101.

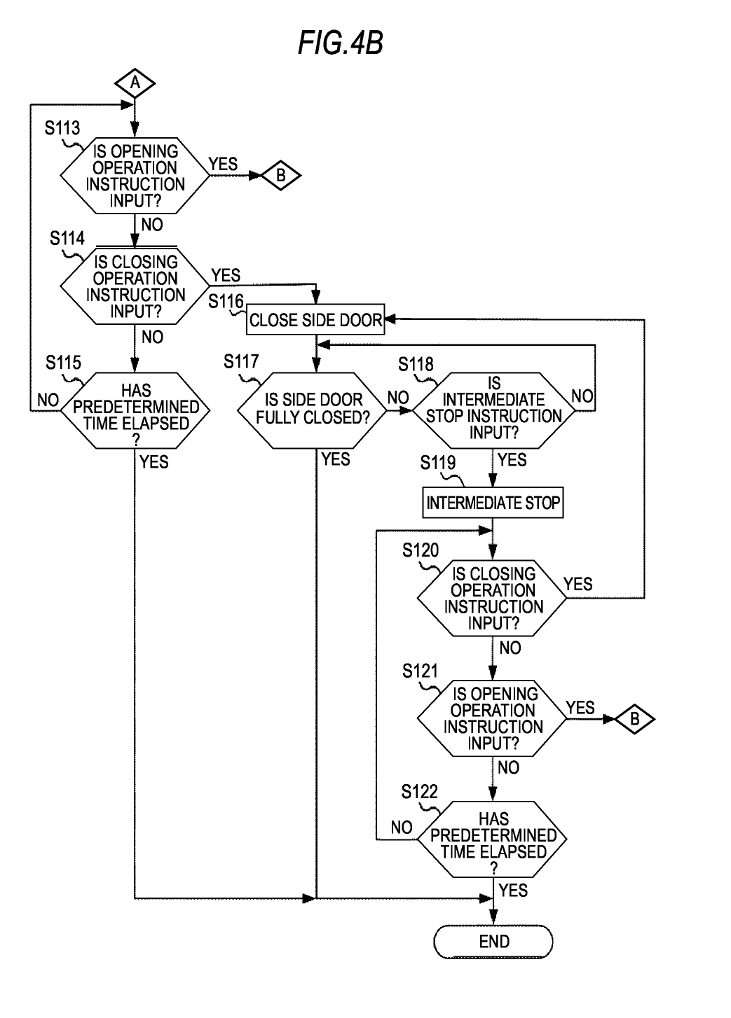

The control device 104 is a control unit as a controller configured to control the whole automatic door operating device for a vehicle 301. Alternatively, the control device 104 can control other configuration components of the vehicle 100. The control device 104 includes a CPU 302 that executes processing operations such as various calculations, controls, determinations, and a ROM 303 which stores various control programs (for example, the program shown in FIG. 4) and the like executed by the CPU 302. Further, the control device 104 includes a RAM 304 which temporarily stores data while being executed by the CPU 302, input data or the like, and a non-volatile memory 305 such as a flash memory or SRAM. The door opening and closing drive unit 102, the automatic opening operation switch 201, the automatic closing operation switch 202, the door lock driving device 306, the wireless signal transmission and reception unit 308, and the opening and closing state detecting sensor 309 are electrically connected to the control device 104. In addition, ID for identifying the vehicle 100 is stored in the non-volatile memory 305.

The door lock driving device 306 is a mechanism which is provided in the side door 101 to lock or unlock the side door 101, and has an insertion opening for a key for manual locking and unlocking by the user. The door lock driving device 306 is able to manually lock or unlock the side door 101 by the user inserting the key into the insertion opening and turning the key in a predetermined direction, or is able to automatically lock or unlock the side door 101 when an opening and closing instruction is output from the control device 104.

The wireless signal transmission and reception unit 308 transmits an ID information request signal at a predetermined time interval (transmission time interval) towards the outside of the vehicle 100. Further, the wireless signal transmission and reception unit 308 receives an ID information signal transmitted from a predetermined wireless transmitter. The wireless transmitter is a mobile device separate from the vehicle 100, such as a portable key, a smart phone, and a tablet, having a communication function such as wireless communication. The wireless transmitter holds ID information indicating an ID of a predetermined vehicle in a memory unit. When an ID information request signal is received, the wireless transmitter transmits an ID information signal including the ID information specifying the ID of a predetermined vehicle which is stored in its own memory unit. The wireless signal transmission and reception unit 308 receives the ID information signal.

The opening and closing state detecting sensor 309 detects depending on a detection start command from the control device 104, whether the side door 101 is opened (open state) or is closed (closed state), and transmits an opening and closing state signal indicating the opening and closing state of the side door 101 to the control device 104. Further, when the side door 101 is fully opened, the opening and closing state detecting sensor 309 transmits a fully open signal indicating that the side door 101 is fully opened to the control device 104, whereas when the side door 101 is fully closed, the opening and closing state detecting sensor 309 transmits a fully closed signal indicating that the side door 101 is fully closed to the control device 104.

Subsequently, the automatic opening operation and the automatic closing operation of the side door 101 according to the present embodiment will be described.

In the present embodiment, the automatic opening operation of the side door 101 is set such that the side door 101 is automatically opened while the user touches the automatic opening operation switch 201. In other words, when the user desires the automatic opening operation to automatically open the side door 101, the user inputs the opening operation instruction to the vehicle 100 by pressing down the automatic opening operation switch 201 and holds a state where the automatic opening operation switch 201 is pressed down and held. At this time, when the automatic opening operation switch 201 is touched by the user, the automatic opening operation switch 201 transmits the opening operation instruction information to the control device 104. When the opening operation instruction information is received, the control device 104 drives the door opening and closing drive unit 102 so as to perform an automatic opening operation of the side door 101 to move the side door 101 to a predetermined position (in the present embodiment, fully opened position). In this manner, in the present embodiment, the control device 104 controls the door opening and closing drive unit 102 so as to perform the automatic opening operation of the side door 101 only while the user directly touches the automatic opening operation switch 201.

However, when touching end information is received as the intermediate stop instruction information from the automatic opening operation switch 201 before the side door 101 is moved to a fully opened position (state that does not reach the fully opened state), the control device 104 controls the door opening and closing drive unit 102 so as to stop the movement of the side door 101 in the middle of the automatic opening operation. In other words, in the present embodiment, during the automatic opening operation, when the user desires to stop the side door 101 in the middle of the automatic opening operation, the user releases the hand touching and holding the automatic opening operation switch 201 for maintaining the automatic opening operation from the automatic opening operation switch 201. The automatic opening operation switch 201 detecting the separation transmits the touching end information to the control device 104. When the touching end information is received before the side door 101 is fully opened, the control device 104 determines the touching end information as intermediate stop instruction information, and causes the door opening and closing drive unit 102 to stop the automatic opening operation of the side door 101. Thus, during the automatic opening operation, it is possible to stop the side door 101 according to the user's intention. It is possible to restart the automatic opening operation by the user pressing again the automatic opening operation switch 201 and continuing to press down after the intermediate stop, or it is possible to automatically close the side door 101 which has been opened once by the user pressing down the automatic closing operation switch 202 and holding the pressing down after the intermediate stop.

The automatic closing operation of the side door 101 is set such that the side door 101 is automatically closed while the user touches the automatic closing operation switch 202. In other words, when the user desires the automatic closing operation to automatically close the side door 101, the user inputs the closing operation instruction into the vehicle 100 by pressing down the automatic closing operation switch 202 and holds a state where the automatic closing operation switch 202 is pressed down and held. At this time, when the automatic closing operation switch 202 is touched by the user, the automatic closing operation switch 202 transmits the closing operation instruction information to the control device 104. When the closing operation instruction information is received, the control device 104 drives the door opening and closing drive unit 102 so as to perform an automatic closing operation of the side door 101 to move the side door 101 to a predetermined position (in the present embodiment, fully closed position). In this manner, in the present embodiment, the control device 104 controls the door opening and closing drive unit 102 so as to perform the automatic closing operation of the side door 101 only while the user directly touches the automatic closing operation switch 202.

However, when the touching end information is received as the intermediate stop instruction information from the automatic closing operation switch 202 before the side door 101 is moved to a fully closed position (state that does not reach the fully closed state), the control device 104 controls the door opening and closing drive unit 102 so as to stop the movement of the side door 101 in the middle of the automatic closing operation. In other words, in the present embodiment, during the automatic closing operation, when the user desires to stop the side door 101 in the middle of the automatic closing operation, the user releases the hand touching and holding the automatic closing operation switch 202 for holding the automatic closing operation from the automatic closing operation switch 202. The automatic closing operation switch 202 detecting the separation transmits the touching end information to the control device 104. When the touching end information is received before the side door 101 is fully closed, the control device 104 determines the touching end information as intermediate stop instruction information, and causes the door opening and closing drive unit 102 to stop the automatic closing operation of the side door 101. Thus, during the automatic closing operation, it is possible to stop the side door 101 according to the user's intention. It is possible to restart the automatic closing operation by the user pressing the automatic closing operation switch 202 again and continuing to press down after the intermediate stop, or it is possible to automatically open the side door 101 which is closed part way by the user pressing down the automatic opening operation switch 201 and continuing to press down after the intermediate stop.

FIGS. 4A and 4B are flow charts showing a processing procedure of an automatic opening and closing operation of the side door 101 according to the present embodiment.

In step S101, the control device 104 causes the wireless signal transmission and reception unit 308 to transmit an ID information request signal. In step S102, the control device 104 determines whether or not the wireless signal transmission and reception unit 308 receives the ID information signal. In other words, when the wireless signal transmission and reception unit 308 receives a predetermined ID information signal, and the ID information signal is transmitted from the wireless signal transmission and reception unit 308, the control device 104 determines that the ID information signal is received, and proceeds to step S104. In contrast, when the ID information signal is not transmitted from the wireless signal transmission and reception unit 308, the control device 104 determines that the ID information signal is not received, and proceeds to step S103. In step S103, the control device 104 determines whether or not a transmission time interval has elapsed from step S101. For example, referring to timing equipment such as a timer, when the transmission time interval has elapsed after the ID information request signal is transmitted in step S101, the control device 104 returns to step S101, whereas when transmission time interval has not elapsed, the control device 104 returns to step S102.

In step S104, the control device 104 extracts ID information from the received ID information signal, and compares the ID information and the ID stored in the non-volatile memory 305 so as to determine whether or not the ID information received in the wireless signal transmission and reception unit 308 coincides with the stored ID. In other words, the control device 104 determines whether or not the ID information contained in the received ID information signal corresponds to the ID information held by the vehicle 100. When they match, the control device 104 proceeds to step S105, whereas when the IDs do not match, the control device 104 returns to step S101.

In step S105, the control device 104 determines whether the user inputs an opening operation instruction through an automatic opening operation switch 201 based on a detection result of the automatic opening operation switch 201. When the user presses down the automatic opening operation switch 201, the automatic opening operation switch 201 transmits opening operation instruction information to the control device 104. Therefore, when the opening operation instruction information is received from the automatic opening operation switch 201, the control device 104 determines that the user has input the opening operation instruction, and proceeds to step S107. In contrast, when the opening operation instruction information is not received from the automatic opening operation switch 201, the control device 104 proceeds to step S106.

In step S106, the control device 104 determines whether a predetermined time has elapsed after the IDs are coincident in step S104. For example, referring to the timing equipment such as a timer, when the predetermined time has not elapsed, the control device 104 returns to step S105 whereas when the predetermined time has elapsed, the control device 104 returns to step S101.

In step S107, the control device 104 transmits the detection start command to the opening and closing state detecting sensor 309, causes the opening and closing state detecting sensor 309 to detect whether the side door 101 is in an open state or in a closed state, and obtains an opening and closing state signal indicating the detection result from the opening and closing state detecting sensor 309. In addition, the opening and closing state signal is a signal indicating an open state when the side door 101 is opened, and a signal indicating a closed state when the side door 101 is closed.

In step S108, the control device 104 determines whether the side door 101 is in an open state or in a closed state based on the opening and closing state signal obtained in step S107. In the closed state, the control device 104 proceeds to step S109. Since the side door 101 in the open state is already opened, the control device 104 ends the process.

In step S109, the control device 104 controls the door lock driving device 306 so as to make the door lock 307 be in an unlocked state, and controls the door opening and closing drive unit 102 to automatically open the side door 101. At this time, the user touches and holds the automatic opening operation switch 201. In other words, while the user touches the automatic opening operation switch 201, the automatic opening operation of the side door 101 continues.

In step S110, the control device 104 determines whether the side door 101 is fully opened or not, according to the detection result by the opening and closing state detecting sensor 309. As described above, when the side door 101 is fully opened, the opening and closing state detecting sensor 309 transmits a fully open signal to the control device 104. Therefore, when the fully open signal is received, the control device 104 determines that the side door 101 is moved to a fully opened position and is in a fully open state, and thus ends the process. In contrast, when the fully open signal is not received, the control device 104 proceeds to step S111.

In step S111, the control device 104 determines whether the user inputs an intermediate stop instruction through the automatic opening operation switch 201 or not, based on the detection result of the automatic opening operation switch 201. When a transition is made to a state where the user is not touching the automatic opening operation switch 201 by the user separating the hand touching the automatic opening operation switch 201 therefrom, the automatic opening operation switch 201 transmits touching end information as intermediate stop instruction information to the control device 104. Therefore, when the touching end information is received from the automatic opening operation switch 201, since the control device 104 has determined in step S110 that the side door 101 has not reached the fully opened state, and thus determines that the user inputs the intermediate stop instruction and proceeds to step S112. In contrast, when the touching end information is not received from the automatic opening operation switch 201, the control device 104 proceeds to step S110.

In step S112, the control device 104 controls the door opening and closing drive unit 102 so as to stop the movement of the side door 101 in the middle of the automatic opening operation. In other words, since the user releases the hand touching the automatic opening operation switch 201 from the switch 201 before the side door 101 is fully opened, the control device 104 recognizes that the user changes the state of the automatic opening operation switch to a non-contact state by the touching end information, and stops the automatic opening operation of the side door 101.

Referring to FIG. 4B, after the automatic opening operation of the side door 101 is stopped once in step S112, the user may desire (i) the automatic opening operation again (step S113 described below; YES), (ii) the automatic closing of the side door 101 (step S114 described below; YES), and (iii) the manual opening and closing operation of the side door 101 or maintaining the side door 101 in a state where it is opened part way for a moment (step S115 described below; YES). In step S113, the control device 104 determines whether the user inputs an opening operation instruction through the automatic opening operation switch 201, based on the detection result of the automatic opening operation switch 201. When the opening operation instruction information is received from the automatic opening operation switch 201, the control device 104 proceeds to step S109 (FIG. 4A) and restarts the automatic opening operation of the side door 101.

When the opening operation instruction information is not received from the automatic opening operation switch 201, in step S114, the control device 104 determines whether or not the user inputs a closing operation instruction through the automatic closing operation switch 202, based on the detection result of the automatic closing operation switch 202. When the user presses down the automatic closing operation switch 202, the automatic closing operation switch 202 transmits the closing operation instruction information to the control device 104. Therefore, when closing operation instruction information is received from the automatic closing operation switch 202, the control device 104 determines that the user inputs the closing operation instruction, and proceeds to step S116. In contrast, when closing operation instruction information is not received from the automatic closing operation switch 202, the control device 104 proceeds to step S115.

In step S115, the control device 104 determines whether or not a predetermined time has elapsed after the side door 101 is stopped in step S112. For example, referring to the timing equipment such as a timer, when the predetermined time has not elapsed, the control device 104 returns to step S113 whereas when the predetermined time has elapsed, the control device 104 ends the process.

In step S116, the control device 104 controls the door opening and closing drive unit 102 so as to automatically close the side door 101. At this time, the user touches and holds the automatic closing operation switch 202. In other words, while the user touches the automatic closing operation switch 202, the automatic closing operation of the side door 101 continues.

In step S117, the control device 104 determines whether the side door 101 is fully closed or not, according to the detection result by the opening and closing state detecting sensor 309. As described above, when the side door 101 is fully closed, the opening and closing state detecting sensor 309 transmits a fully closed signal to the control device 104. Therefore, when the fully closed signal is received, the control device 104 determines that the side door 101 is moved to a fully closed position and is in a fully closed state, and thus ends the process. In contrast, when the fully closed signal is not received, the control device 104 proceeds to step S118.

In step S118, the control device 104 determines whether the user inputs an intermediate stop instruction through the automatic closing operation switch 202 or not, based on the detection result of the automatic closing operation switch 202. When a transition is made to a state where the user is not touching the automatic closing operation switch 202 by the user separating the hand touching the automatic closing operation switch 202 therefrom, the automatic closing operation switch 202 transmits touching end information as intermediate stop instruction information to the control device 104. Therefore, when the touching end information is received from the automatic closing operation switch 202, since the control device 104 has determined in step S117 that the side door 101 has not reached the fully closed state, and thus determines that the user inputs the intermediate stop instruction and proceeds to step S119. In contrast, when the touching end information is not received from the automatic closing operation switch 202, the control device 104 proceeds to step S117.

In step S119, the control device 104 controls the door opening and closing drive unit 102 so as to stop the movement of the side door 101 in the middle of the automatic closing operation. In other words, since the user releases the hand touching the automatic closing operation switch 202 from the switch 202 before the side door 101 is fully closed, the control device 104 recognizes that the user changes the state of the automatic closing operation switch 202 to a non-contact state by the touching end information, and stops the automatic closing operation of the side door 101.

Subsequently, the control device 104 performs step S120, step S121, and step S122 respectively similarly to step S114, step S113, and step S115.

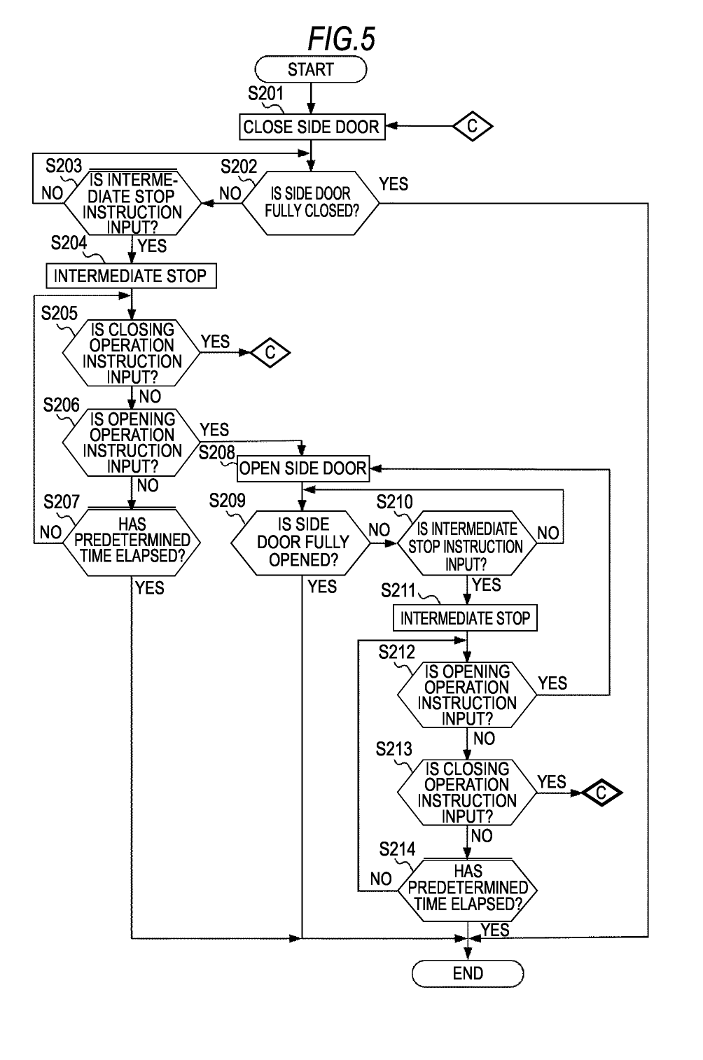

Next, an operation to automatically close the side door 101 in a state where the side door 101 is opened (fully opened state or a state between fully opened and fully closed) will be described using FIG. 5.

In a state where the side door 101 is opened, when the user presses down the automatic closing operation switch 202, the process shown in FIG. 5 starts. In other words, when the opening operation instruction information is received from the automatic closing operation switch 202 in a state where the side door 101 is opened, the control device 104 performs the automatic opening and closing operation of the side door 101 according to the program shown in FIG. 5.

In step S201, the control device 104 controls the door opening and closing drive unit 102 so as to automatically close the side door 101. At this time, the user touches and holds the automatic closing operation switch 202. In other words, while the user touches the automatic closing operation switch 202, the automatic closing operation of the side door 101 continues. In step S202, the control device 104 determines whether or not the side door 101 is fully closed, according to the detection result by the opening and closing state detecting sensor 309. When it is determined that the side door 101 is fully closed, the control device 104 ends the present process. When it is determined that the side door 101 is not fully closed, in step S203, the control device 104 determines whether the user inputs an intermediate stop instruction through an automatic closing operation switch 202 based on a detection result of the automatic closing operation switch 202. When it is determined that the user inputs the intermediate stop instruction, in step S204, the control device 104 controls the door opening and closing drive unit 102 so as to stop the movement of the side door 101 in the middle of the automatic closing operation. In contrast, when it is determined that the user has not input the intermediate stop instruction, the control device 104 proceeds to step S202.

In step S205, the control device 104 determines whether or not the user inputs a closing operation instruction through the automatic closing operation switch 202 based on a detection result of the automatic closing operation switch 202. When the closing operation instruction information is received from the automatic closing operation switch 202, the control device 104 proceeds to step S201 and restarts the automatic closing operation of the side door 101. When the closing operation instruction information is not received from the automatic closing operation switch 202, in step S206, the control device 104 determines whether or not the user inputs an opening operation instruction through an automatic opening operation switch 201 based on a detection result of the automatic opening operation switch 201. When it is determined that the user inputs the opening operation instruction, in step S208, the control device 104 controls the door opening and closing drive unit 102 so as to automatically open the side door 101. At this time, the user touches and holds the automatic opening operation switch 201. In other words, while the user touches the automatic opening operation switch 201, the automatic opening operation of the side door 101 continues. When it is determined that the user does not input the opening operation instruction, in step S207, the control device 104 determines whether or not a predetermined time has elapsed after the side door 101 is stopped in step S204. When the predetermined time has not elapsed, the process returns to step S205, in contrast, when the predetermined time has elapsed, the process ends.

In step S209, the control device 104 determines whether or not the side door 101 is fully opened, according to the detection result by the opening and closing state detecting sensor 309. When it is determined that the side door 101 is fully opened, the control device 104 ends the process. In contrast, when it is determined that the side door 101 is not fully opened, in step S210, the control device 104 determines whether the user inputs an intermediate stop instruction through the automatic opening operation switch 201 based on a detection result of the automatic opening operation switch 201. When it is determined that the user inputs the intermediate stop instruction, in step S211, the control device 104 controls the door opening and closing drive unit 102 so as to stop the movement of the side door 101 in the middle of the automatic opening operation. In contrast, when it is determined that the user does not input the intermediate stop instruction, the control device 104 proceeds to step S209. Subsequently, the control device 104 respectively performs step S212, step S213, and step S214 similarly to step S206, step S205, and step S207.

As described above, in the present embodiment, the automatic opening operation of the side door 101 is started by the user directly touching the input unit (in the present embodiment, the automatic opening operation switch 201) which inputs the opening operation instruction to the automatic door operating device for a vehicle 301 and the side door 101 is automatically opened only while the user directly touches the input unit. Therefore, the user is able to correctly input an intent to start the automatic opening operation of the side door 101 and an intent to continue the automatic opening operation to the automatic door operating device for a vehicle 301. Further, since the automatic door operating device for a vehicle 301 detects the user directly touching the input unit for inputting the opening operation instruction and controls the automatic opening operation of the side door 101 according to the detection result, the intent of the user for the automatic opening operation can be correctly recognized.

Further, the control device 104 detects the user directly touching the automatic opening operation switch 201 to recognize the input of the opening operation instruction and an instruction to continue the opening operation without determining the status of the user by analyzing an image captured by a camera as in the related art. Accordingly, even when it is dark at night, it rains or is foggy, or a plurality of people are present in the vicinity of the user who is operating, the control device 104 is able to correctly know what type of instruction is input by the user.

Further, in the present embodiment, since the side door 101 is automatically opened by the user touching the input unit for the opening operation instruction, it is possible to open the side door 101 without pulling the door handle 105 as in the related art. Therefore, it is possible to perform the opening and closing of the door without providing the door handle 105 used in the opening and closing of the door in the side door 101 as in the related art. In this manner, by doing away with the door handle 105, an improvement in vehicle design can be expected.

Further, in the present embodiment, it is assumed that the automatic opening operation of the side door 101 is performed only while the user directly touches the input unit for the opening operation instruction. Accordingly, the automatic opening operation of the side door 101 is performed in a state where the user touches a part of the side door 101 that is displaced in the direction to automatically open the side door 101. Therefore, the user is able to perform the automatic opening operation while knowing the side door 101 being automatically opened. Therefore, even if the user inputs a wrong instruction, the user is able to immediately recognize that the user has input the wrong instruction. For example, when the automatic opening and closing operation of the side door 101 is stopped in the middle of the operation and is restarted, when the user intended to give an opening operation instruction but the user gives a closing operation instruction by mistake, the user is able to sense the side door 101 being automatically closed contrary to the intention of the user. Therefore, the user is able to immediately recognize that the input instruction is incorrect.

In JP 2010-13824A (Reference 1), the door is stopped in the middle of the operation, when a camera recognizes that the user's hand form is different from the form indicating the operation which is currently being performed. When a control device detects the different form of the hand, the control device stops the movement of the door. For example, when the user opens the hand within a shooting area of the camera, it is regarded as a trigger and the automatic opening operation of the door is started, however, when the user desires to stop the automatic opening operation of the door in the middle of the operation, the intention of an intermediate stop by the user needs to be presented to the camera. Accordingly, as a result of the photographic image analysis by the camera, when the control device determines that the user provides an intermediate stop indication, even when the user does not intend to make an intermediate stop, the automatic opening and closing operation of the door is to stop. Further, since the user needs to change the form of the hand, there is a possibility of a time lag occurring until the door actually stops from when the user wanted to stop the door.

In contrast, in the present embodiment, when the user releases a part of the user's body (for example, hand) from directly touching a predetermined input unit, it is detected that a part of the user's body, which has previously touched the input unit, no longer touches the input unit The displacement of the side door 101 which automatically moves is caused to stop based on the detection result (in the present embodiment, touching end information). Accordingly, it is possible to accurately reflect the intention of the intermediate stop of the user. Further, it is possible to input the intermediate stop instruction by simply releasing the hand touching the input unit without a special operation such as changing the form of the hand, so that it is possible to stop the automatic opening operation of the side door 101 with a satisfactory response.

In addition, although in the present embodiment, the automatic opening operation switch 201 and the automatic closing operation switch 202 are implemented as a capacitance sensor, it is not limited thereto. In the present embodiment, it is important that an opening operation instruction is input by the user touching directly and then the automatic opening operation of the side door 101 is performed only while the user continues touching. Therefore, as long as direct touching by the user for the automatic opening operation can be detected and the touching and holding can be detected, any switch may be used. In other words, as long as the user touching can be detected physically (touch, press, or the like), electrically, thermally, and optically, and a detection signal can be transmitted to the control device 104, any switch may be used as an input unit of the opening operation instruction.

Further, although in the present embodiment, the automatic opening operation switch 201 is provided in the door handle 105 and the automatic closing operation switch 202 is provided in the belt molding 106, the positions where the automatic opening operation switch 201 and the automatic closing operation switch 202 are disposed are not limited thereto. For example, the automatic opening operation switch 201 and the automatic closing operation switch 202 together may be provided in the door handle 105 or the belt molding 106, or provided in the garnish 103. Further, at least one of the automatic opening operation switch 201 and the automatic closing operation switch 202 may be provided on the inside side of the vehicle 100 of the side door 101. In other words, the automatic opening operation switch 201 and the automatic closing operation switch 202 may be provided in a part of the side door 101. Alternatively, at least one of the automatic opening operation switch 201 and the automatic closing operation switch 202 may be provided in an element (for example, an instrument panel, a dashboard, or the like) present within the vehicle 100.

Further, although in the present embodiment, with respect to the automatic closing operation of the side door 101, the side door 101 is controlled so as to be automatically closed only while the user touches the automatic closing operation switch 202, it is not limited thereto. For example, the automatic closing operation may be performed only by the user pressing down the automatic closing operation switch 202 without continuing touching.

Further, although in the present embodiment, the automatic opening operation switch 201 as the input unit of the opening operation instruction and the automatic closing operation switch 202 as the input unit of the closing operation instruction are provided separately, the input unit of the opening operation instruction and the input unit of the closing operation instruction may be configured with the same elements. For example, one contact sensor may be used as both the input unit of the opening operation instruction and the input unit of the closing operation instruction. In this case, for example, the inputs of the opening operation instruction and the closing operation instruction may be distinguished depending on the number of times when the user presses the common contact sensor. As another example, it may be assumed that the user touches the common contact sensor one time and continues touching the contact sensor at the time of the automatic opening operation, and without continuing touching, the user presses down the contact sensor two times within a predetermined time interval at the time of the automatic closing operation.

Further, a contact sensor, a switch, or the like as an input unit for intermediate stop may be provided in a part of the side door 101. Further, for the purpose of intermediate stop of the side door 101 being displaced automatically, a device may be provided which detects an abrupt speed change of the side door 101 while performing the automatic opening operation (automatic closing operation) of the side door 101 so as to stop the operation of the side door 101 in the middle of the operation when it detects an abrupt speed change. In the automatic operation (the automatic opening operation and the automatic closing operation) of the side door 101, an acceleration, a velocity, an angular velocity, and the like of the displacement of the side door 101 are set to a predetermined value. In other words, in the middle of the automatic operation, the side door 101 is displaced according to the acceleration, the velocity, and the angular velocity which are set. Therefore, when it is detected that the movement deviates from set values or a permissible range of the acceleration, the velocity, the angular velocity, and the like in the middle of the automatic operation, the detection result may be regarded as the intermediate stop instruction information. For example, an acceleration sensor may be provided in the side door 101 to monitor the acceleration of the side door 101 in the middle of the automatic operation, when it is detected that the acceleration deviates from the permissible range as the set value, the automatic operation (the automatic opening operation and the automatic closing operation) of the side door 101 may be stopped. Further, an example in which the angular velocity is monitored by a gyro sensor may be included. By such a configuration, for example, the automatic opening operation of the side door 101 can be stopped by the user pressing down a part of the side door 101 (for example, a garnish or a door panel part) in the middle of the automatic opening operation.

In addition, the automatic opening operation and the automatic closing operation of the side door 101 according to the present embodiment is not limited to that of the side door, and the operation may be employed at doors such as a back door and a trunk lid which are present in a vehicle. For example, the automatic opening operation switch 201 and the automatic closing operation switch 202 may be provided in an opening and closing body as an object (for example, the back door or the trunk lid), or may be provided in the elements of the vehicle 100 in the vicinity thereof. Particularly, in a case of the back door or the trunk lid, the automatic opening operation switch 201 and the automatic closing operation switch 202 may be provided in an emblem.

### Embodiment 2

In a second embodiment, the side door 101 is first automatically opened by a predetermined amount before the full automatic opening operation of the side door 101. In other words, in the present embodiment, before the opening operation instruction is input, the side door 101 in a fully closed state is automatically opened by a predetermined amount such that it does not become the fully opened state. Herein, automatically opening the side door 101 by a predetermined amount such that it does not become the fully opened state will be referred to as “a pop-up opening operation”, and “an instruction from the user for automatically opening the side door 101 by a predetermined amount so as not to be automatically fully opened” will be referred to as “a pop-up instruction”.

In the present embodiment, when the user presses down the automatic opening operation switch 201 two times within a predetermined time interval, the automatic opening operation switch 201 detects the pop-up instruction from the user and transmits pop-up instruction information regarding the pop-up instruction to the control device 104. In addition, although in the present embodiment, the user inputs the pop-up instruction using the automatic opening operation switch 201, the contact sensor as an input unit of the pop-up instruction may be provided separately from the automatic opening operation switch 201 in any region of the side door 101.

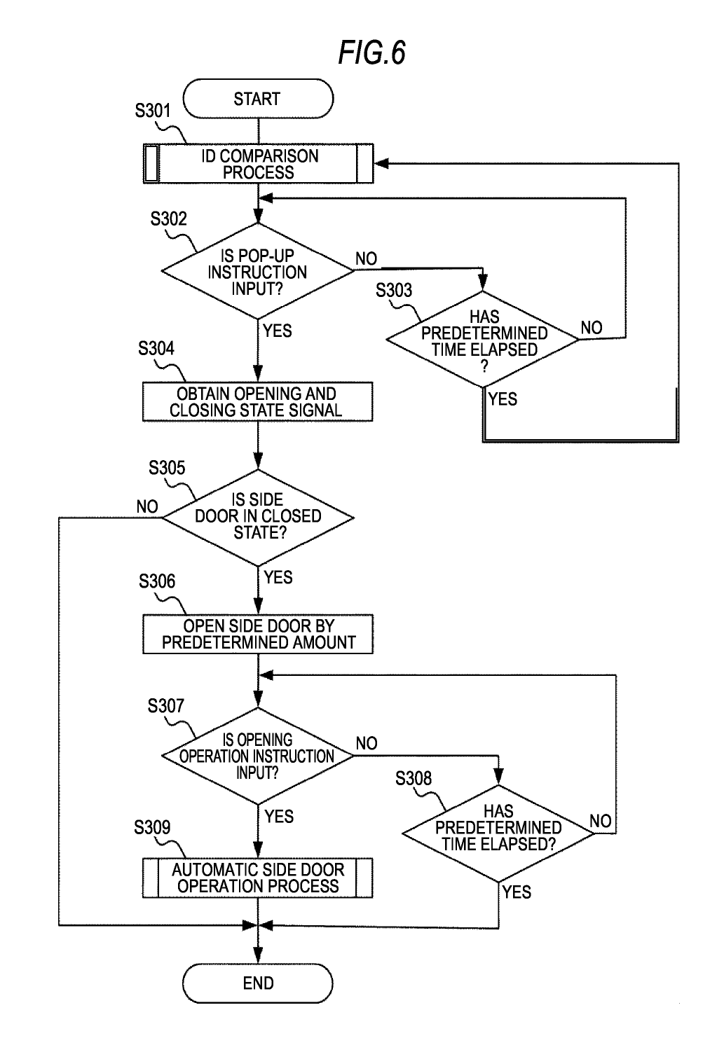

FIG. 6 is a flow chart showing a processing procedure of the automatic opening and closing operation of the side door 101 according to the present embodiment.

In addition, in the present embodiment, the side door 101 is a swing type door.

In step S301, the control device 104 performs steps S101 to S104 of FIG. 4A to perform a comparison process between the user ID and the ID registered in the vehicle 100. In step S301, when it is approved as a result of an ID comparison, in step S302, the control device 104 determines whether or not the user inputs a pop-up instruction through the automatic opening operation switch 201, based on the detection result of the automatic opening operation switch 201. when the user presses down the automatic opening operation switch 201 two times within a predetermined time interval, the automatic opening operation switch 201 transmits pop-up instruction information to the control device 104. Therefore, when the pop-up instruction information is received from the automatic opening operation switch 201, the control device 104 determines that the user inputs the pop-up instruction, and proceeds to step S304. In contrast, when the pop-up instruction information is not received from the automatic opening operation switch 201, the control device 104 proceeds to step S303.

In step S303, the control device 104 determines whether or not a predetermined time has elapsed after IDs are coincident in step S301. For example, referring to the timing equipment such as a timer, when the predetermined time has not elapsed, the control device 104 returns to step S302, whereas when the predetermined time has elapsed, the control device 104 returns to step S301.

In step S304, the control device 104 transmits a detection start command to the opening and closing state detecting sensor 309 to cause the opening and closing state detecting sensor 309 to detect whether the side door 101 is in an open state or in a closed state, and obtains an opening and closing state signal indicating the detection result from the opening and closing state detecting sensor 309. In step S305, the control device 104 determines whether the side door 101 is in an open state or is in a closed state, based on the opening and closing state signal obtained in step S304. When the side door 101 is in the closed state, the control device 104 proceeds to step S306. When the side door 101 is in the open state, the side door 101 is already opened, so that the control device 104 ends the process.

In step S306, the control device 104 controls the door lock driving device 306 so as to make the door lock 307 to be in an unlock state, and controls the door opening and closing drive unit 102 so as to automatically open the side door 101 by a predetermined amount such that the side door 101 is not fully opened. In other words, a pop-up opening operation is performed.

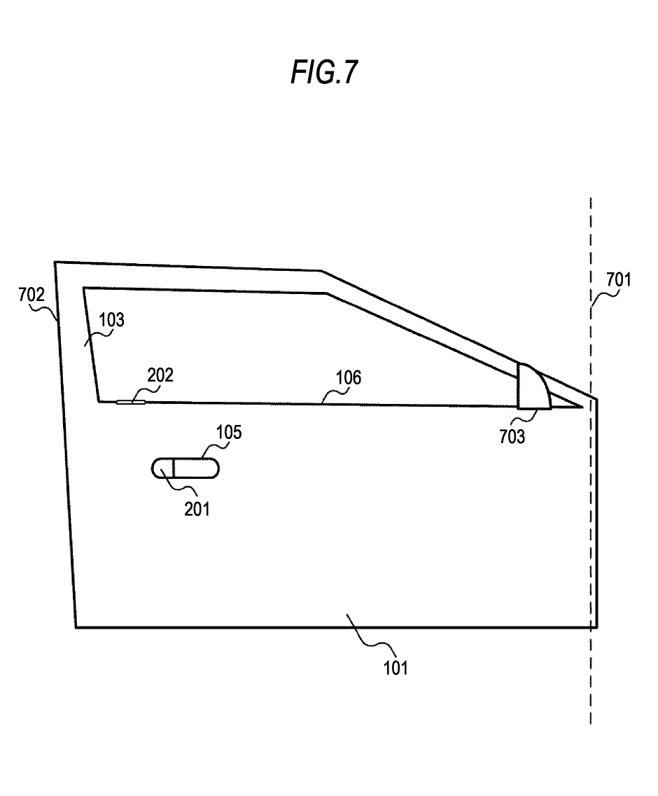

FIG. 7 is a side view of a side door 101 according to the present embodiment.

The side door 101 is a swing type according to the present embodiment rotates about a rotation axis 701. In a state where the side door 101 is opened by a predetermined amount such that the side door 101 is not fully opened, it is preferable that the amount of movement (the amount of opening) of an end portion 702, from a state where the side door 101 is fully closed, on the opposite side of the rotation axis 701 at the time of the swing of the side door 101 be the same as or less than the amount of protrusion (the length of a protrusion portion) of the door mirror 703 toward the outside of the vehicle 100. In other words, it is preferable that the predetermined amount be the same as the amount of protrusion or less than the amount of protrusion. For example, when the amount of protrusion of the door mirror 703 from the side door 101 is 200 mm, it is preferable that the predetermined amount (the amount of movement) be 200 mm and or less. The door mirror 703 is an element of the vehicle 100 positioned outermost of the side door 101. Therefore, generally, there would be no problem to consider whether or not other objects are present closer in the region of the vehicle 100 side than the door mirror 703. Therefore, when the position of the end portion 702 after the pop-up opening operation is closer on the vehicle 100 side than the position of the outermost portion of the door mirror 703, even without performing an obstacle detection, as long as there are no special circumstances (for example, a case where the end of a rod shape is positioned closer on the vehicle 100 side than the outermost portion of the door mirror 703, and the like), it can be said that the side door 101 can be subjected to the pop-up opening operation without colliding with the obstacle.

In step S307, the control device 104 determines whether or not the user inputs an opening operation instruction through the automatic opening operation switch 201, based on the detection result of the automatic opening operation switch 201. When the user desires the automatic opening operation after the side door 101 performs the pop-up opening operation in step S306, the user touches and holds the automatic opening operation switch 201 while pressing down the automatic opening operation switch 201. In other words, when the user presses down the automatic opening operation switch 201 for the automatic opening operation after the pop-up opening operation, the automatic opening operation switch 201 transmits the opening operation instruction information to the control device 104. Therefore, when the opening operation instruction information is received from the automatic opening operation switch 201, the control device 104 determines that the user inputs the opening operation instruction, and proceeds to step S309. In step S309, the control device 104 performs steps S109 to S122 in FIGS. 4A and 4B. In contrast, when the opening operation instruction information is not received from the automatic opening operation switch 201, the control device 104 proceeds to step S308.

In step S308, the control device 104 determines whether or not a predetermined time has elapsed after the pop-up opening operation in step S306 has ended. For example, referring to the timing equipment such as a timer, when the predetermined time has not elapsed, the control device 104 returns to step S307. In contrast, after the pop-up opening operation, the side door 101 is in a state where it is opened by a predetermined amount. Therefore, depending on the user's desire, in some cases, the side door 101 is desired to be opened manually. In this case, the user may not input the opening operation instruction. Therefore, when the predetermined time has elapsed, the control device 104 ends the process.

In this manner, in the present embodiment, before the automatic opening operation is performed, the pop-up opening operation is performed, and the side door 101 is at once automatically opened to the position in which the side door 101 is not fully opened. Therefore, after the pop-up opening operation, the side door 101 is not in a fully closed state, since a gap is formed between the end portion of the side door 101 and the body of the vehicle 100, the user can open manually the side door 101 by placing the hand in the gap without using a door handle. In other words, it is possible to manually open the side door 101 without using the door handle 105.

Further, since the user is able to operate the opening and closing of the side door 101 also manually by performing the pop-up opening operation, the user can select whether to perform the automatic opening operation or to manually open the side door 101 after the pop-up opening operation.

Furthermore, it is possible to construct a system that does not necessarily require obstacle detection in the pop-up opening operation, by setting the opening amount (a predetermined amount) of the door at the time of door opening in the pop-up opening operation to the amount of protrusion of the door mirror 703 or less.

In addition, the position where the door mirror 703 is provided is not limited to the side door 101, and may be a vehicle body part other than the side door 101 of the vehicle 100.

### Embodiment 3

In a third embodiment, the side door 101 may have a lock reservation function to automatically lock the side door 101 after the side door 101 is fully closed.

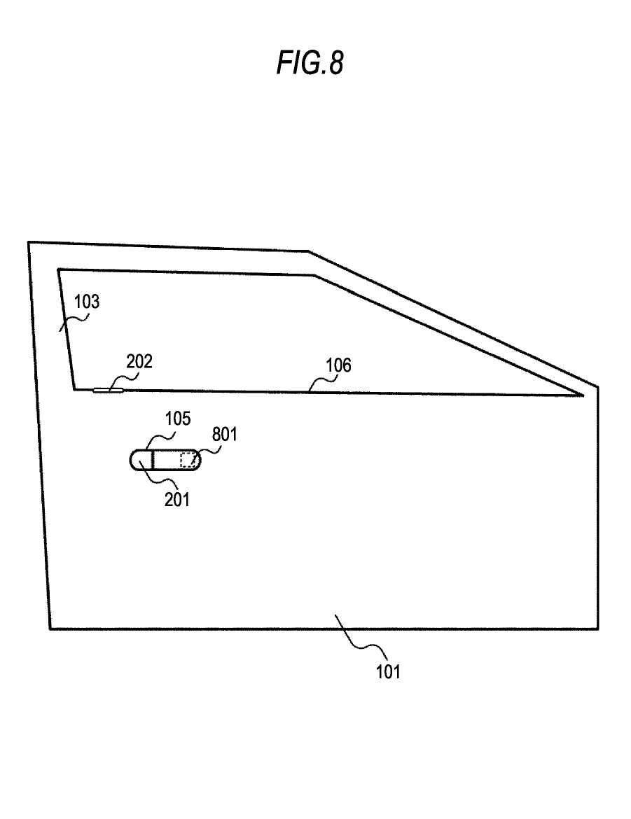

FIG. 8 is a side view of a side door 101 according to the present embodiment.

In FIG. 8, a lock reservation switch 801, through which the user inputs the lock reservation instruction, is provided in the door handle 105. The contact sensor or the like may be used also as the lock reservation switch 801, similarly to the automatic opening operation switch 201 and the automatic closing operation switch 202. When the lock reservation switch 801 is pressed down by the user, the switch 801 transmits lock reservation instruction information indicating that the user inputs the lock reservation instruction to the control device 104.

When the lock reservation instruction information is received before the closing operation instruction information is received from the automatic closing operation switch 202, the control device 104 recognizes that the user desires a lock reservation and automatically locks the door lock 307 after the side door 101 reaches the fully closed state. In other words, when the reservation instruction information is received and it is detected that the side door 107 is fully closed, the control device 104 controls the door lock driving device 306 so as to lock the door lock 307.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An automatic door operating device for a vehicle comprising:
an input unit which is provided in a portion of a vehicle and to which an instruction to automatically open a door of a vehicle is input by a user's touch;
a door drive unit configured to automatically open door based on the instruction input by the input unit; and
a controller configured to control the door drive unit so as to automatically open the door only while the user touches the input unit.

2. The automatic door operating device for a vehicle according to claim 1,
wherein the controller is configured to stop a displacement of the door which is automatically opened based on a determination that there is a transition from a state where the input unit is touched by the user to a state where the input unit is not touched by the user.

3. The automatic door operating device for a vehicle according to claim 1, further comprising:
a second input unit which is provided in a portion of the vehicle, and to which an instruction to automatically close the door of the vehicle is input by a user's touch,
wherein the door drive unit is configured to automatically close the door based on the instruction to close the door input by the second input unit.

4. The automatic door operating device for a vehicle according to claim 2, further comprising:
a second input unit which is provided in a portion of the vehicle, and to which an instruction to automatically close the door of the vehicle is input by a user's touch,
wherein the door drive unit is configured to automatically close the door based on the instruction to close the door is input by the second input unit.

5. The automatic door operating device for a vehicle according to claim 3,
wherein the controller is configured to control the door drive unit so as to automatically close the door only while the user touches the second input unit.

6. The automatic door operating device for a vehicle according to claim 1,
wherein the controller is configured to control the door drive unit by an instruction, which is input by the user, such that the door of the vehicle is opened by a predetermined amount that is less than a full open amount of.

7. The automatic door operating device for a vehicle according to claim 2,
wherein the controller is configured to control the door drive unit by an instruction, which is input by the user, such that the door of the vehicle is opened by a predetermined amount that is less than a full open amount of.

8. The automatic door operating device for a vehicle according to claim 3,
wherein the controller is configured to control the door drive unit by an instruction, which is input by the user, such that the door of the vehicle is opened by a predetermined amount that is less than a full open amount of.

9. The automatic door operating device for a vehicle according to claim 4,
wherein the controller is configured to control the door drive unit by an instruction, which is input by the user, such that the door of the vehicle is opened by a predetermined amount that is less than a full open amount of.

10. The automatic door operating device for a vehicle according to claim 5,
wherein the predetermined amount is equal to or less than an amount of protrusion to the outside of the vehicle from the vehicle, of a door mirror provided in the vehicle.

11. The automatic door operating device for a vehicle according to claim 1, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

12. The automatic door operating device for a vehicle according to claim 2, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

13. The automatic door operating device for a vehicle according to claim 3, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

14. The automatic door operating device for a vehicle according to claim 4, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

15. The automatic door operating device for a vehicle according to claim 5, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

16. The automatic door operating device for a vehicle according to claim 6, further comprising:
a lock mechanism configured to automatically lock the door of the vehicle after the door of the vehicle is in a fully closed state, based on a determination that the door of the vehicle is closed and an instruction to automatically lock the door of the vehicle input from the user.

17. A method for operating an automatic door for a vehicle, comprising:
receiving an instruction to automatically open a door of a vehicle by a user's touch to an input unit which is provided in a portion of a vehicle;
automatically opening the door based on the instruction only while the user touches the input unit.

18. The method for operating the automatic door for the vehicle according to claim 17,
wherein, a displacement of the door is stopped based on a determination that there is a transition from a state where the input unit is touched by the user to a state where the input unit is not touched by the user.

19. The method for operating the automatic door for the vehicle according to claim 18, further comprising:
automatically closing the door based on an instruction to close the door input to a second input unit which is provided in a portion of the vehicle, the instruction to automatically close the door being input by a user's touch to the second input unit.

20. The method for operating the automatic door for the vehicle according to claim 19,
wherein the door is automatically closed only while the user touches the second input unit.
